(19) United States
(12) Patent Application Publication
(10) Pub. No.: US 2022/0018660 A1
(43) Pub. Date: Jan. 20, 2022

(54) Virtual Grid Dictionary Based Target Heading Class Intention Recognition Method and Device

(71) Applicant: National University of Defense Technology, Changsha City (CN)

(72) Inventors: Yulong Zhang, Beijing (CN); Zhong Liu, Changsha City (CN); Li Chen, Yinchuan City (CN); Songyan Zhu, Beijing (CN); Min Li, Beijing (CN); Chao Chen, Changsha City (CN); Longfei Zhang, Xianyang City (CN); Jing Yang, Qingdao City (CN); Xingxing Liang, Changsha City, (CN); Naifu Xu, Anyang City (CN)

(21) Appl. No.: 17/379,024

(22) Filed: Jul. 19, 2021

(30) Foreign Application Priority Data
Jul. 20, 2020 (CN) 202010697761.2

(51) Int. Cl. G01C 21/20; G06K 9/72

(52) U.S. Cl. CPC G01C 21/20; G06K 9/72

(57) ABSTRACT

The application relates to a virtual grid dictionary based target heading class intention recognition method and a virtual grid dictionary based target heading class intention recognition device. The method includes the steps of: acquiring the longitude and latitude data of a task space, and transforming the task space into a longitude-latitude grid according to the longitude and latitude data; setting up a first virtual grid dictionary corresponding to a task target according to the longitude and latitude of the task target corresponding to a flight target and the longitude-latitude grid; determining whether the flight target is switched to a straight flight mode according to the longitudes and latitudes and current longitudes and latitudes of historical flight paths of the flight target; querying the task target in the flight path of the flight target according to a sensitive area corresponding to the preset task target and the first virtual grid dictionary when the flight target is in the straight flight mode, where the task target is queried according to a situation that whether the flight target is in the range of the sensitive area; and determining the task type of the flight target according to the type of the task target in an expected flight path. The method can improve the efficiency of intention recognition.

### CROSS REFERENCE TO RELATED APPLICATION

The application relates to the technical field of intention recognition, and in particular, to a virtual grid dictionary based target heading class intention recognition method and device.

### BACKGROUND OF THE INVENTION

At present, there is no intention identification method for air combat units in open channels, relevant discussions mainly focus on situation cognition concepts and technical frameworks, and in relatively feasible intention identification schemes, methods such as situation templates, expert systems, Bayesian network and deep learning and the like are also advocated to use. The implementation of the schemes above needs to be supported by a lot of scientifically certified practical cases and data, a lot of time and effort need to be invested in early-stage case base construction and training, and in case that the number of sensitive air and ground units is relatively small, relatively stable flight intention recognition results cannot be directly given according to simple information such as deployments of the enemy and ourselves, the flight paths of enemy targets, and the like, thus, the efficiency of intention recognition is low.

### SUMMARY OF THE INVENTION

Therefore, for solving the technical problems above, it is necessary to provide a virtual grid dictionary based target heading class intention recognition method and device, which can solve the problem that the efficiency of intention recognition performed by using low traditional methods is low.

A virtual grid dictionary based target heading class intention recognition method, the method including:

acquiring the longitude and latitude data of a task space, and according to the longitude and latitude data, transforming the task space into a longitude-latitude grid; and according to the longitude and latitude of a task target corresponding to a flight target and the longitude-latitude grid, setting up a first virtual grid dictionary corresponding to the task target, where the first virtual grid dictionary is configured to query the task target through latitudes and longitudes;

according to the longitudes and latitudes and current longitudes and latitudes of historical flight paths of the flight target, determining whether the flight target is switched to a straight flight mode;

when the flight target is in the straight flight mode, according to a sensitive area corresponding to the preset task target and the first virtual grid dictionary, querying the task target in the flight path of the flight target, where the task target is queried according to a situation that whether the flight target is in the range of the sensitive area; and

determining the task type of the flight target according to the type of the task target in the expected flight path.

In one of embodiments, the method also includes the steps of: acquiring the longitude and latitude endpoint values of the task space as Latₛ, Latₑ, Lonₛ and Lonₑ, and according to a preset length, partitioning the task space into a longitude-latitude grid with a latitude value interval of L_{Dlat} and a longitude value interval of L_{Dlon}:

$${N}_{lat} \text{\textasciitilde} \{ \begin{matrix}[ {Lat}_{s} , {Lat}_{s} + {N}_{lat} \times {L}_{Dlat} ] , {N}_{lat} = 1 \\ [ {Lat}_{s} + ( {N}_{lat} - 1 ) \times {L}_{Dlat} , {Lat}_{s} + {N}_{lat} \times {L}_{Dlat} ] , {N}_{lat} > 1 \\ [ {Lat}_{s} + ( {N}_{lat} - 1 ) \times {L}_{Dlat} , {Lat}_{e} ] , {N}_{lat} = ⌈ {Lat}_{e} / {L}_{Dlat} ⌉\end{matrix} \\ {N}_{lon} \text{\textasciitilde} \{ \begin{matrix}[ {Lon}_{s} , {Lon}_{s} + {N}_{lon} \times {L}_{Dlon} ] , {N}_{lon} = 1 \\ [ {Lon}_{s} + ( {N}_{lon} - 1 ) \times {L}_{Dlon} , {Lon}_{s} + {N}_{lon} \times {L}_{Dlon} ] , {N}_{lon} > 1 \\ [ {Lon}_{s} + ( {N}_{lon} - 1 ) \times {L}_{Dlon} , {Lon}_{e} ] , {N}_{lon} = ⌈ {Lon}_{e} / {L}_{Dlon} ⌉\end{matrix}$$

where the latitude sequence number of the longitude-latitude grid is Nₗₐₜ, and the longitude sequence number of the longitude-latitude grid is Nₗₒₙ.

In one of the embodiments, the method also includes the steps of: acquiring a sensitive distance D of the flight target;

according to the sensitive distance D, obtaining a longitude sequence number increment and a latitude sequence number increment as follows:

ΔNₗₐₜ=┌D/L_{Dlat}┐,ΔNₗₒₙ=┌D/L_{Dlon}┐

where, ΔNₗₐₜ refers to the longitude sequence number increment, ΔNₗₒₙ refers to the latitude sequence number increment, L_{Dlat} refers to the grid longitude length of the longitude-latitude grid, and the L_{Dlon} refers to the grid latitude length; setting up a first-order dictionary of the first virtual grid dictionary according to the longitude sequence number in the longitude-latitude grid; setting up a second-order dictionary of the first virtual grid dictionary according to the latitude sequence number in the longitude-latitude grid; and setting up a third-order dictionary according to the first-order dictionary and the second-order dictionary, where a first virtual network is set up by the query logics of the first-order dictionary, the second-order dictionary and the third-order dictionary.

In one of embodiments, the method also includes the step of: according to the historical and current longitudes and latitudes of more than two historical flight paths, when an included angle between an arc formed by the line connection of two points on the ellipsoidal surface of the earth and the due north direction of the earth and a course angle corresponding to the current latitudes and longitudes are less than threshold values, determining whether the flight target is switched to the straight flight mode.

In one of the embodiments, the method also includes the steps of: when the flight target is in the straight flight mode, determining an expected flight path of the flight target according to a course angle of the straight flight mode; according to a sensitive area corresponding to the preset task target, querying whether the flight target enters the sensitive area, if so, querying the task target corresponding to the sensitive area in the first virtual grid dictionary; and acquiring the task target in the expected flight path.

In one of the embodiments, the method also includes the steps of: when the type of the task target in the expected flight path is a ground target, determining that the task type of the flight target is a task to ground; and when the type of the task target in the expected flight path is an aerial target, determining that the task type of the flight target is a task to air.

In one of the embodiments, the method also includes the steps of: according to the longitude and latitude ranges corresponding to the takeoff-landing area of the flight target and the longitude-latitude grid, setting up a second virtual grid dictionary corresponding to the takeoff-landing area, where the second virtual grid dictionary is configured to query the takeoff-landing area through the latitude and longitude ranges; according to the search scope and the second virtual grid dictionary, determining a takeoff-landing area in the search scope; when the type of the task target in the expected flight path is the takeoff-landing area, determining that the task type of the flight target is a withdrawal and course reversal task; and when there is no search task target or takeoff-landing area in the search scope, determining that the task type of the flight target is a mobile retrograding task.

A virtual grid dictionary based target heading class intention recognition device, the device including:

a virtual grid dictionary module, configured to acquire the longitude and latitude data of a task space, and according to the longitude and latitude data, transform the task space into a longitude-latitude grid; according to the longitude and latitude of a task target corresponding to a flight target and the longitude-latitude grid, build a first virtual grid dictionary corresponding to the task target, where in the first virtual grid dictionary, the task target is queried through latitudes and longitudes;

a flight determination module, configured to determine whether the flight target is switched to a straight flight mode according to the longitudes and latitudes and current longitudes and latitudes of historical flight paths of the flight target;

a target querying module, configured to query the task target in the flight path of the flight target according to a sensitive area corresponding to the preset task target and the first virtual grid dictionary when the flight target is in the straight flight mode, where the task target is queried according to a situation that whether the flight target is in the range of the sensitive area; and

an intention recognition module, configured to determine the task type of the flight target according to the type of the task target in the expected flight path.

Computer equipment, including a memory and a processor, where the memory stores computer programs, and when the processor executes the computer programs, the following steps are implemented:

acquiring the longitude and latitude data of a task space, and according to the longitude and latitude data, transforming the task space into a longitude-latitude grid; and according to the longitude and latitude of a task target corresponding to a flight target and the longitude-latitude grid, setting up a first virtual grid dictionary corresponding to the task target, where the first virtual grid dictionary is configured to query the task target through latitudes and longitudes;

according to the longitudes and latitudes of historical and current flight paths of the flight target, determining whether the flight target is switched to a straight flight mode;

when the flight target is in the straight flight mode, according to a sensitive area corresponding to the preset task target and the first virtual grid dictionary, querying the task target in the flight path of the flight target, where the task target is queried according to a situation that whether the flight target is in the range of the sensitive area; and

determining the task type of the flight target according to the type of the task target in the expected flight path.

A computer-readable storage medium in which computer programs are stored, and when the computer programs are executed by the processor, the following steps are implemented:

acquiring the longitude and latitude data of a task space, and according to the longitude and latitude data, transforming the task space into a longitude-latitude grid; and according to the longitude and latitude of a task target corresponding to a flight target and the longitude-latitude grid, setting up a first virtual grid dictionary corresponding to the task target, where in the first virtual grid dictionary, the task target is queried through latitudes and longitudes;

according to the longitudes and latitudes of historical and current flight paths of the flight target, determining whether the flight target is switched to a straight flight mode;

when the flight target is in the straight flight mode, according to a sensitive area corresponding to the preset task target and the first virtual grid dictionary, querying the task target in the flight path of the flight target, where the task target is queried according to a situation that whether the flight target is in the range of the sensitive area; and

determining the task type of the flight target according to the type of the task target in the expected flight path.

In the virtual grid dictionary based target heading class intention recognition method, the virtual grid dictionary based target heading class intention recognition device, the computer equipment and the storage medium, through carrying out grid partition on the task space, because a battle space is large, after grid partition is performed on the battle space, the data volume is huge, and the direct use of data will result in that hardware parts are hard to bear, thus, the first virtual grid dictionary corresponding to the task target is set up based on the latitude-longitude grid, that is, the task target is queried from the longitude-latitude grid, and through the longitude and latitude sequence numbers in the longitude-latitude grid, the task target can be directly queried through the first virtual grid dictionary. When a flight task is performed, once the historical flight path of a flight target keeps consistent with the current flight course of the flight target, the flight target is switched to a straight flight mode, therefore, intention recognition is implemented through the crucial steps of firstly, determining whether a flight target is switched to the straight flight mode, then, in the straight flight mode, querying a task target in the flight path of the flight target based on the sensitive range of the task target, and determining the task type of the flight target according to the type of the task target. The invention is not restricted to the number of task targets in a task space, the calculated data volume is less, and the efficiency is high.

### BRIEF DESCRIPTION OF THE FIGURES

FIG. 1 is a process diagram of a virtual grid dictionary based target heading class intention recognition method in an embodiment;

FIG. 2 is a schematic diagram of a terrestrial sphere in an embodiment;

FIG. 3 is a process diagram of a sensitive range mode in another embodiment;

FIG. 4 is a structure block diagram of a virtual grid dictionary based target heading class intention recognition device in an embodiment; and

FIG. 5 is an internal structure diagram of computer equipment in an embodiment.

### DETAILED DESCRIPTION OF THE PREFERRED EMBODIMENTS

To illustrate the purpose, technical solution and advantages of this application more clearly, the following further describes the application detailedly with reference to accompanying drawings and embodiments. It should be understood that the embodiments described herein are only used to interpret this application, and are not intended to limit this application.

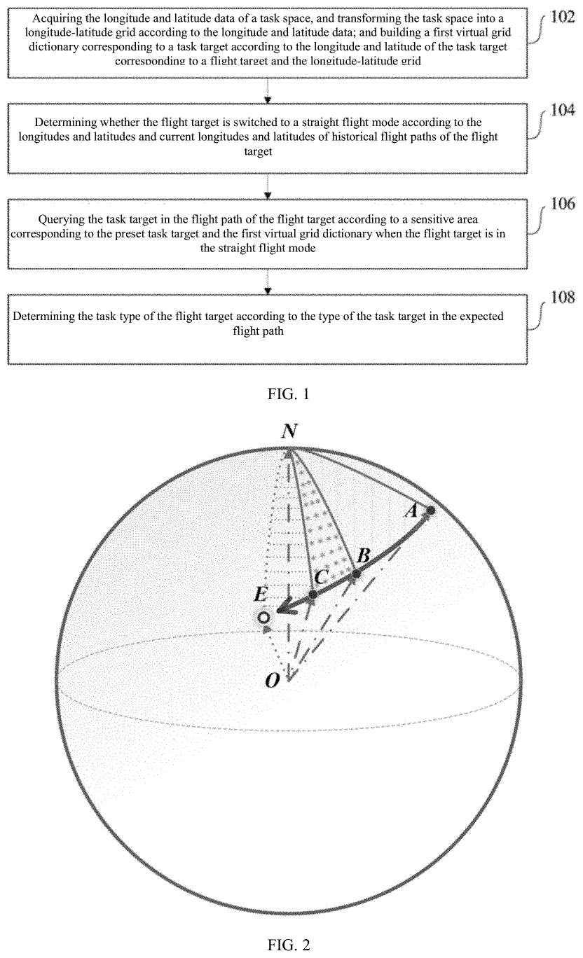

In an embodiment, as shown in FIG. 1, a virtual grid dictionary based target heading class intention recognition method is provided, and includes the following steps that:

Step 102, the longitude and latitude data of a task space is acquired, and the task space is transformed into a longitude-latitude grid according to the longitude and latitude data; and according to the longitude and latitude of a task target corresponding to a flight target and the longitude-latitude grid, a first virtual grid dictionary corresponding to the task target is set up.

The task space is partitioned into the longitude-latitude grid at preset longitude and latitude intervals, and the selection of the longitude and latitude intervals can be determined according to factors such as the size of the task space, the number of flight targets, and the like. The flight targets may be aircrafts such as unmanned aerial vehicles, fighters, and bombers, and the like.

The task target refer to a facility in the task space, for example, important facilities such as fighters, tank rallies and the like, generally speaking, in a non-combat task, the task target is motionless, thus, the longitude and latitude of the task target can be acquired, and then the location of the task target in the longitude-latitude grid can be queried, based on the location of the task target in the longitude-latitude grid, a first virtual grid dictionary can be set up, and the definition of the first virtual grid dictionary is that a specific task target can be queried through the longitude and latitude of the task target.

Step 104, according to the longitudes and latitudes and current longitudes and latitudes of historical flight paths of the flight target, whether the flight target is switched to a straight flight mode is determined.

The straight flight mode refers to that the flight path is an approximate straight line, and when the flight target is in the straight flight mode, in general, the flight target has a specific task target, and at this moment, the task intention recognition of the flight target needs to be performed.

Step 106, when the flight target is in the straight flight mode, according to a sensitive area corresponding to the preset task target and the first virtual grid dictionary, the task target in the flight path of the flight target is queried.

Because of in the straight flight mode, the flight path of the flight target may be assumed to be a straight line, that is, the expected flight path is a straight line, the task target can be queried according to that whether the flight target is within the range of the sensitive area.

Step 108, the task type of the flight target is determined according to the type of the task target in the expected flight path.

After the expected flight path is got, the task target in the expected flight path is queried simultaneously through a searching point set preset in the path, so that the intention of the flight target can be inferred.

In the virtual grid dictionary based target heading class intention recognition method, through carrying out grid partition on the task space, because a battle space is large, after grid partition is performed on the battle space, the data volume is huge, and the direct use of data will result in that hardware parts are hard to bear, thus, the first virtual grid dictionary corresponding to the task target is set up based on the latitude-longitude grid, that is, the task target is queried from the longitude-latitude grid, and through the longitude and latitude sequence numbers in the longitude-latitude grid, the task target can be directly queried through the first virtual grid dictionary. When a flight task is performed, once the historical flight path of a flight target keeps consistent with the current flight course of the flight target, the flight target is switched to a straight flight mode, therefore, intention recognition is implemented through the crucial steps of firstly, determining whether a flight target is switched to the straight flight mode, then, in the straight flight mode, querying a task target in the flight path of the flight target based on the sensitive range of the task target, and determining the task type of the flight target according to the type of the task target. The invention is not restricted to the number of task targets in a task space, the calculated data volume is less, and the efficiency is high.

In one of embodiments, the step of setting up a longitude-latitude grid includes the substeps of:

acquiring the longitude and latitude endpoint values of the task space as Latₛ, Latₑ, Lonₛ and Lonₑ, and according to a preset length, partitioning the task space into a longitude-latitude grid with a latitude value interval of L_{Dlat} and a longitude value interval of L_{Dlon}:

$${N}_{lat} \text{\textasciitilde} \{ \begin{matrix}[ {Lat}_{s} , {Lat}_{s} + {N}_{lat} \times {L}_{Dlat} ] , {N}_{lat} = 1 \\ [ {Lat}_{s} + ( {N}_{lat} - 1 ) \times {L}_{Dlat} , {Lat}_{s} + {N}_{lat} \times {L}_{Dlat} ] , {N}_{lat} > 1 \\ [ {Lat}_{s} + ( {N}_{lat} - 1 ) \times {L}_{Dlat} , {Lat}_{e} ] , {N}_{lat} = ⌈ {Lat}_{e} / {L}_{Dlat} ⌉\end{matrix} \\ {N}_{lon} \text{\textasciitilde} \{ \begin{matrix}[ {Lon}_{s} , {Lon}_{s} + {N}_{lon} \times {L}_{Dlon} ] , {N}_{lon} = 1 \\ [ {Lon}_{s} + ( {N}_{lon} - 1 ) \times {L}_{Dlon} , {Lon}_{s} + {N}_{lon} \times {L}_{Dlon} ] , {N}_{lon} > 1 \\ [ {Lon}_{s} + ( {N}_{lon} - 1 ) \times {L}_{Dlon} , {Lon}_{e} ] , {N}_{lon} = ⌈ {Lon}_{e} / {L}_{Dlon} ⌉\end{matrix}$$

where the latitude sequence number of the longitude-latitude grid is Nₗₐₜ, and the longitude sequence number of the longitude-latitude grid is Nₗₒₙ.

In another embodiment, the step of setting up a first virtual network dictionary includes the substeps of: acquiring a sensitive distance D of the flight target; according to the sensitive distance D, obtaining a longitude sequence number increment and a latitude sequence number increment as follows:

ΔNₗₐₜ=┌D/L_{Dlat}┐,ΔNₗₒₙ=┌D/L_{Dlon}┐

where, ΔNₗₐₜ refers to the longitude sequence number increment, ΔN_{long} refers to the latitude sequence number increment, L_{Dlat} refers to the grid longitude length of the longitude-latitude grid, and the L_{Dlon} refers to the grid latitude length of the longitude-latitude grid; according to the longitude sequence number in the longitude-latitude grid, setting up a first-order dictionary of the first virtual grid dictionary; according to the latitude sequence number in the longitude-latitude grid, setting up a second-order dictionary of the first virtual grid dictionary; and according to the first-order dictionary and the second-order dictionary, setting up a third-order dictionary, where a first virtual network is set up by the query logics of the first-order dictionary, the second-order dictionary and the third-order dictionary. The query logics refer to that the contents of the second-order dictionary can be queried through the first-order dictionary, the contents of the third-order dictionary can be queried through the second-order dictionary, and a target list of corresponding types is queried through the third-order dictionary.

Specifically, the longitude and latitude values of our aircraft under the current situation are respectively Lon_{A} and Lat_{A}, corresponding longitude and latitude sequence number values in the grid are respectively N_{Alon} and N_{Alat}, the maximum longitude and latitude sequence values of the latticed task space are respectively N_{Alonmax} and N_{Alatmax}, and the serial number of the task target is J10-b.

Firstly, a first-order dictionary is set up by taking latitude sequence number elements in a following latitude sequence number set Aₗₐₜ of air unit sensitive areas as key values:

$${A}_{lat} = \{ \begin{matrix}\begin{matrix}\{ 1 , 2 , . . . , {N}_{Alat} , {N}_{Alat} + 1 , . . . , {N}_{Alat} + Δ {N}_{lat} \} , \\ {N}_{Alat} - Δ {N}_{lat} \leq 0 {N}_{Alat} + Δ {N}_{lat} < {N}_{lat max}\end{matrix} \\ \begin{matrix}\{ {N}_{Alat} - Δ {N}_{lat} , {N}_{Alat} - Δ {N}_{lat} + 1 , . . . , {N}_{Alat} , {N}_{Alat} + 1 , . . . , \\ {N}_{Alat} + Δ {N}_{lat} \} , {N}_{Alat} - Δ {N}_{lat} > 0 {N}_{Alat} + Δ {N}_{lat} < {N}_{lat max}\end{matrix} \\ \begin{matrix}\{ 1 , 2 , . . . , {N}_{Alat} , {N}_{Alat} + 1 , . . . , {N}_{lat max} \} , \\ {N}_{Alat} - Δ {N}_{lat} \leq 0 {N}_{Alat} + Δ {N}_{lat} \geq {N}_{lat max}\end{matrix} \\ \begin{matrix}\{ {N}_{Alat} - Δ {N}_{lat} , {N}_{Alat} - Δ {N}_{lat} + 1 , . . . , {N}_{Alat} , {N}_{Alat} + 1 , . . . , \\ {N}_{lat max} \} , {N}_{Alat} - Δ {N}_{lat} > 0 {N}_{Alat} + Δ {N}_{lat} \geq {N}_{lat max}\end{matrix}\end{matrix}$$

secondly, indexed by each latitude key value, a second-order dictionary is set up by taking longitude sequence number elements in a following longitude sequence number set Aₗₒₙ of air unit sensitive areas as key values:

$${A}_{lon} = \{ \begin{matrix}\begin{matrix}\{ 1 , 2 , . . . , {N}_{lon} , {N}_{lon} + 1 , . . . , {N}_{lon} + Δ {N}_{lon} \} , \\ {N}_{Alon} - Δ {N}_{lon} \leq 0 {N}_{Alon} + Δ {N}_{lon} < {N}_{lon max}\end{matrix} \\ \begin{matrix}\{ {N}_{lon} - Δ {N}_{lon} , {N}_{lon} - Δ {N}_{lon} + 1 , . . . , {N}_{lon} , {N}_{lon} + 1 , . . . , \\ {N}_{lon} + Δ {N}_{lon} \} , {N}_{Alon} - Δ {N}_{lon} > 0 {N}_{Alon} + Δ {N}_{lon} < {N}_{lon max}\end{matrix} \\ \begin{matrix}\{ 1 , 2 , . . . , {N}_{lon} , {N}_{lon} + 1 , . . . , {N}_{lon max} \} , \\ {N}_{Alon} - Δ {N}_{lon} \leq 0 {N}_{Alon} + Δ {N}_{lon} \geq {N}_{lon max}\end{matrix} \\ \begin{matrix}\{ {N}_{lon} - Δ {N}_{lon} , {N}_{lon} - Δ {N}_{lon} + 1 , . . . , {N}_{lon} , {N}_{lon} + 1 , . . . , \\ {N}_{lon max} \} , {N}_{Alon} - Δ {N}_{lon} > 0 {N}_{Alon} + Δ {N}_{lon} \geq {N}_{lon max}\end{matrix}\end{matrix}$$

finally, indexed by the longitudes and latitudes in the first-order dictionary and the second-order dictionary, a third-order dictionary is set up, specifically, an aerial unit sensitive target list of our own side is set up or updated by taking the type of the task target as an index. Relevant logics are as follows:

if elements Nₗₐₜ in the latitude sequence number set Aₗₐₜ already exist in the virtual grid dictionary:

if elements Nₗₒₙ in the longitude serial number set Aₗₒₙ already exist in the virtual grid dictionary:
if a sensitive aerial target list indexed by “Air_sensitive_targets” already exists:
add the serial number J10-b of our aerial target to the list
else:
set up a third-order dictionary by taking “Air_sensitive_targets” as the key and an aerial unit sensitive target list as the value, and add the serial number J10-b of our aerial target to the list
else:
set up a third-order dictionary by taking the element Nton in the longitude sequence number set Aton as the key, and index a third-order dictionary by Nton
set up a third-order dictionary by taking “Air_sensitive_targets” as the key and an aerial unit sensitive target list as the value, and add the serial number J10-b of our aerial target to the list
else:
set up a first-order dictionary by taking the element Nlat in the latitude sequence number set Alat as the key, and index a second-order dictionary by taking Nlat as the key
set up a second-order dictionary by taking the element Nton in the longitude sequence number set Aton as keys, and index a third-order dictionary by taking Nton as the key
set up a third-order dictionary by taking “Air_sensitive_targets” as the key and an aerial unit sensitive target list as the value, and add the serial number J10-b of our aerial target to the list.

In one of the embodiments, the step of determining whether the flight target is switched to a straight flight mode includes: according to the historical and current longitudes and latitudes of more than two historical flight paths, when an included angle between an arc formed by the line connection of two points on the spherical surface of the earth and the due north direction of the earth and a course angle corresponding to the current latitudes and longitudes are less than threshold values, determining whether the flight target is switched to the straight flight mode.

Specifically, an appropriate detection time interval T is taken, T₀ refers to a current moment, and T₋₁ and T₋₂ respectively refer to T₀−T and T₀−2T moments before the current moment. By setting the longitude and latitude values of a coordinate C of an enemy plane at the current moment as (L_{atc}, L_{onc}) and setting the course as an included angle h₀ measured clockwise with the due north direction, the longitude and latitude values of a coordinate B at the T₋₁ moment are (lat_{B}, lon_{B}), and the longitude and latitude values of a coordinate A at the T₋₂ moment are (lat_{A}, lon_{A}). The earth is regarded as a sphere, so, the step of determining whether an aircraft is switched to a straight flight state may be transformed into a step of determining whether an included angle between a flight path over the surface of the sphere and the due north direction keeps unchanged and consistent with the course angle at the T₀ moment. But in view of actual meteorological conditions and the influence of flight control, an angle consistence determination threshold value hₜₕ is set for considering that once a deviation between any two of an included angle between an arc AB on the sphere and the due north direction, an included angle between an arc AC and the due north direction, and the course angle at the T₀ moment is less than the threshold value h_{thrd}, the aircraft may be considered to be in the straight flight state.

In the process of specific solution, the earth is approximately regarded as a sphere with a radius of R_{E}, the geocenter point is set as O, and the north pole point is set as N, as shown in FIG. 2, an angle ∠AOB formed by connecting endpoints AB of an arc opposite to a point N on a spherical triangle NAB to the geocenter point O is set as n₁, an angle ∠NOB formed by connecting endpoints NB of an arc opposite to the point A to the geocenter point O is set as ac, and an angle ∠NOA formed by connecting endpoints NA of an arc opposite to the point B to the geocenter point O is set as b₁; and in a spherical triangle ΔANB, ∠A refers to an included angle between an arc [symbol] and an arc [symbol] on the sphere, ∠B refers to an included angle between the arc [symbol] and an arc [symbol] on the sphere, and ∠N₁ refers to an included angle between the arc [symbol] and the arc [symbol] on the sphere, and also refers to a dihedral angle B-OC-A between a plane NOB and a plane NOA.

Step 1, an included angle between a flight path [symbol] of the flight target at a point B and the due north direction is solved, which can be easily known by a definition below:

$$\{ \begin{matrix}∠ AOB = {n}_{1} \\ ∠ NOA = {b}_{1} = 90 ° - {lat}_{A} \\ ∠ NOB = ac = 90 ° - {lat}_{B} \\ ∠ {N}_{1} = B - ON - A = {lon}_{A} - {lon}_{B}\end{matrix}$$

a known formula of trihedral-angle cosines:

cos(n₁)=cos(b₁)×cos(ac)+sin(b₁)×sin(ac)×cos(B−ON−A)

according to the formula above, cos(n₁) is calculated:

cos(n₁)=cos(90−lat_{A})×cos(90−lat_{B})+sin(90−lat_{A})×sin(90−lat_{B})×cos(lon_{A}−lon_{B})

then, sin(n₁) can be obtained by solving:

sin(n₁)=\sqrt{1−cos²(n₁)}

according to the law of spherical sines:

$$\frac{sin ( A )}{sin ( a c )} = \frac{sin ( B )}{sin ( {b}_{1} )} = \frac{sin ( {N}_{1} )}{sin ( {n}_{1} )}$$

sin(B) can be obtained by solving:

$$sin ( B ) = \frac{sin ( {b}_{1} ) \times sin ( {N}_{1} )}{sin ( {n}_{1} )} = \frac{sin ( 90 - {lat}_{A} ) \times sin ( {lon}_{A} - {lon}_{B} )}{sin ( {n}_{1} )}$$

the degree of the angle B (∠B∈[−90 DEG, 90 DEG]) on the spherical triangle ΔANB is obtained:

$$∠ B = arcsin ( \frac{sin ( 90 - {lat}_{A} ) \times sin ( {lon}_{A} - {lon}_{B} )}{sin ( {n}_{1} )} )$$

To solve the course angle h_{B} of an aircraft at the point B, the obtaining of the angle ∠B is required to be further transformed. By setting the point B as a zero point, a longitude line \vec{BN} as a longitudinal axis and a latitude line passing through the point B as a horizontal axis, the transformation relationship between the course angle h_{B} in different quadrants and the angle ∠B is different:

$${h}_{B} = \{ \begin{matrix}∠ B , & {h}_{B} is in the first quadrant \\ 36 {0}^{∘} - ∠ B , & {h}_{B} is in the second quadrant \\ 180 ° + ∠ B , & {h}_{B} is in the third and fourth quadrant\end{matrix}$$

Step 2, an included angle between a flight path [symbol] the flight target at a point C and the due north direction is solved. Same as the method above, by solving the angle ∠C in the spherical triangle ΔCNB, a course angle h_{C} is obtained by solving.

After the course angle is obtained by calculating, determination also needs to be made according to the threshold value, which is specifically implemented through comparing the difference values of any two of the course angle h₀ at the current moment, the course angle h_{B} at the point B and the course angle h_{C} at the point B, if the difference values are all within the determination threshold h_{thrd}, deducing that the enemy plane is switched to the straight flight mode:

$$\{ \begin{matrix}{d}_{1} = {h}_{0} - {h}_{B} \\ {d}_{2} = {h}_{0} - {h}_{C} \\ {d}_{3} = {h}_{B} - {h}_{C}\end{matrix}$$

when and only when d₁ is less than dₜₕ, d₂ is less than hₜₕ, and d₃ is less than hₜₕ, the aircraft can be identified as being switched to a straight flight mode.

In one of the embodiments, the method also includes the steps of: when the flight target is in the straight flight mode, determining an expected flight path of the flight target according to the course angle of the straight flight mode; according to a sensitive area corresponding to the preset task target, querying whether the flight target enters the sensitive area, if so, querying the task target corresponding to the sensitive area in the first virtual grid dictionary; and acquiring the task target in the expected flight path.

Concretely, a method for determining the coordinates of forward way points is given, under the condition that task target points are dense enough, by setting that an enemy plane is switched to a “straight flight mode” at the current moment and taking that the longest distance of forward searching is Dₘₐₓ, the search spacing distance is Δd and at most n way points are searched forwards, an equation Dₘₐₓ=n×Δd is obtained, the latitude and longitude values of the coordinate C of the enemy plane at the current moment are (lat_{C}, lon_{C}), and the course is an included angle h₀ measured clockwise with the due north direction, so that the coordinate (latₑ, lonₑ) of the i(th) forward searched way point E may be determined by the following method:

if the earth is approximately regarded as a sphere with a radius of R_{E}, it can be known that an operation of solving the longitude and latitude increments of a target at the forward way point is expressed as an operation of solving the length of the arc [symbol] in FIG. 2. An angle ∠COE formed by connecting the endpoints CE of an arc opposite to a point N on a spherical triangle NAB to a geocenter point O is set as n₃, an angle ∠NOE formed by connecting the endpoints NE of an arc opposite to a point C to the geocenter point O is set as c₂, an angle ∠NOC formed by connecting the endpoints NC of an arc opposite to a point E to the geocenter point O is set as be, ∠N₃ is set as an included angle between the arc [symbol] and the arc [symbol] and also set as the longitude difference between the point C and the point E, and ∠C₂ is set as an included angle between the arc [symbol] and the arc [symbol] and also set as a dihedral angle B-OC-A of a plane NOB and a plane NOA.

$$\{ \begin{matrix}{n}_{3} = \frac{i \times Δ d}{{R}_{E}} \times \frac{180 °}{} \\ ∠ NOC = be = 9 {0}^{o} - {lat}_{c}\end{matrix} \\ ∠ {C}_{2} = \{ \begin{matrix}{h}_{B} , & {h}_{B} is in the first and fourth quadrant \\ {h}_{B} - 180 ° , & {h}_{B} is in the second and third quadrant\end{matrix}$$

the coordinate can be obtained by a formula of trihedral-angle cosines:

cos(c₂)=cos(n₃)×cos(be)+sin(n₃)×sin(be)×cos(∠C₂)

c₂ and sin(c₂) can be obtained by solving:

$${c}_{2} = arccos ( cos ( \frac{i \times Δ d}{{R}_{E}} \times \frac{180 °}{} ) \times cos ( 90 ° - {lat}_{C} ) + sin ( \frac{i \times Δ d}{{R}_{E}} \times \frac{180 °}{} ) \times sin ( 9 {0}^{∘} - {lat}_{C} ) \times cos ( ∠ {C}_{2} ) ) \\ sin ( {c}_{2} ) = \sqrt{1 - {cos}^{2} ( {c}_{2} )} \qquad$$

a formula of spherical sines show that:

$$\vert \frac{sin ( {C}_{2} )}{sin ( {c}_{2} )} = \frac{sin ( {N}_{3} )}{sin ( {n}_{3} )} \\ ∠ {N}_{3} = arcsin ( \frac{sin ( {C}_{2} ) \times sin ( {n}_{3} )}{sin ( {c}_{2} )} ) \qquad$$

∠N3 can be obtained by solving:

and the longitude and latitude of the point E can be determined:

$${lat}_{E} = 90 ° - {c}_{2}$$

$${lon}_{E} = \{ \begin{matrix}{lat}_{C} + {N}_{3} , & {h}_{B} is in the first and fourth quadrant \\ {lat}_{C} + {N}_{3 ,} & {h}_{B} is in the second and third quadrant\end{matrix}$$

In one of the embodiments, the task targets include ground targets and aerial targets, thus, a first virtual grid dictionary of ground targets and a first virtual grid dictionary of aerial targets need to be set up successively. In addition, when a flight target performs a task, and even may be a course reversal task, course reversal means that the flight target flies back to the takeoff-landing area, thus, a takeoff-landing area needs to be indicated in the longitude-latitude grid, and a second longitude-latitude grid corresponding to the takeoff-landing area should be set up.

Specifically, according to the longitude and latitude ranges corresponding to the takeoff-landing area of the flight target and the longitude-latitude grids the second virtual grid dictionary corresponding to the takeoff-landing area is set up; and in the second virtual grid dictionary, the takeoff-landing area is queried through the longitude and latitude ranges.

Specifically, the specific logics of the latitude sequence number set Rₗₐₜ and the longitude sequence number set Rₗₒₙ of the takeoff-landing area are as follows:

$${R}_{lat} = \{ \begin{matrix}\begin{matrix}\{ 1 , 2 , . . . , {N}_{lat} , {N}_{lat} + 1 , . . . , {N}_{lat} + Δ {N}_{lat} \} , \\ {N}_{Alat} - Δ {N}_{lat} \leq 0 {N}_{Alat} + Δ {N}_{lat} < {N}_{lat max}\end{matrix} \\ \begin{matrix}\{ {N}_{lat} - Δ {N}_{lat} , {N}_{lat} - Δ {N}_{lat} + 1 , . . . , {N}_{lat} , {N}_{lat} + 1 , . . . , \\ {N}_{lat} + Δ {N}_{lat} \} , {N}_{Alat} - Δ {N}_{lat} > 0 {N}_{Alat} + Δ {N}_{lat} < {N}_{lat max}\end{matrix} \\ \begin{matrix}\{ 1 , 2 , . . . , {N}_{lat} , {N}_{lat} + 1 , . . . , {N}_{lat max} \} , \\ {N}_{Alat} - Δ {N}_{lat} \leq 0 {N}_{Alat} + Δ {N}_{lat} \geq {N}_{lat max}\end{matrix} \\ \begin{matrix}\{ {N}_{lat} - Δ {N}_{lat} , {N}_{lat} - Δ {N}_{lat} + 1 , . . . , {N}_{lat} , {N}_{lat} + 1 , . . . , \\ {N}_{lat max} \} , {N}_{Alat} - Δ {N}_{lat} > 0 {N}_{Alat} + Δ {N}_{lat} \geq {N}_{lat max}\end{matrix}\end{matrix} \\ {R}_{lon} = \{ \begin{matrix}\begin{matrix}\{ 1 , 2 , . . . , {N}_{lon} , {N}_{lon} + 1 , . . . , {N}_{lon} + Δ {N}_{lon} \} , \\ {N}_{Alon} - Δ {N}_{lon} \leq 0 {N}_{Alon} + Δ {N}_{lon} < {N}_{lon max}\end{matrix} \\ \begin{matrix}\{ {N}_{lon} - Δ {N}_{lon} , {N}_{lon} - Δ {N}_{lon} + 1 , . . . , {N}_{lon} , {N}_{lon} + 1 , . . . , \\ {N}_{lon} + Δ {N}_{lon} \} , {N}_{Alon} - Δ {N}_{lon} > 0 {N}_{Alon} + Δ {N}_{lon} < {N}_{lon max}\end{matrix} \\ \begin{matrix}\{ 1 , 2 , . . . , {N}_{lon} , {N}_{lon} + 1 , . . . , {N}_{lon max} \} , \\ {N}_{Alon} - Δ {N}_{lon} \leq 0 {N}_{Alon} + Δ {N}_{lon} \geq {N}_{lon max}\end{matrix} \\ \begin{matrix}\{ {N}_{lon} - Δ {N}_{lon} , {N}_{lon} - Δ {N}_{lon} + 1 , . . . , {N}_{lon} , {N}_{lon} + 1 , . . . , \\ {N}_{lon max} \} , {N}_{Alon} - Δ {N}_{lon} > 0 {N}_{Alon} + Δ {N}_{lon} \geq {N}_{lon max}\end{matrix}\end{matrix}$$

In one of the embodiments, intention recognition is implemented specifically through the steps of: when the type of the task target in the expected flight path is a ground target, determining that the task type of the flight target is a task to ground; and when the type of the task target in the expected flight path is an aerial target, determining that the task type of the flight target is a task to air; moreover, when the type of the task target in the expected flight path is the takeoff-landing area, determining that the task type of the flight target is a retreat and course reversal task; and when there is no search task target or takeoff-landing area in the search scope, determining that the task type of the flight target is a mobile retrograding task.

Specifically, it can be expressed through the following program logics:

if a flight target need to be identified currently is a main combat-to-air aircraft:

for i in n way point sets for forward searching:
calculate the coordinate of the i(th) way point by using a method for determining the coordinates of forward way points
check the sequence numbers of corresponding grid points in a longitude and latitude sequence number comparison table of the virtual grid dictionary
# determine in the following sequential order
if an aerial target list corresponding to grid cells is non-null:
determine that the combat intention of the flight target is attack to air
the aerial target list is an attack-to-air target list of flight targets
break
elif a ground target list corresponding to grid cells is non-null:
determine that the combat intention of the flight target is attack to ground
the ground target list is an attack-to-ground target list of flight targets
break
elif a takeoff-landing area list corresponding to grid cells is non-null:
determine that the combat intention of the flight target is retreat and course reversal
the ground target list is an attack-to-ground target list of flight targets
break
elif i==n:
determine that the combat intention of the flight target is mobile retrograding
output all n predicted way point sets as a mobile retrograding prediction trajectory
break

if a flight target required to be identified currently is a main combat-to-ground aircraft:

for i in n way point sets for forward searching:
calculate the coordinate of the i(th) way point by using a method for determining the coordinates of forward way points
check the sequence numbers of corresponding grid points in a longitude and latitude sequence number comparison table of the virtual grid dictionary
# determine in the following sequential order
if the ground target list corresponding to grid cells is non-null:
determine that the combat intention of the flight target is attack to ground
the ground target list is an attack-to-ground target list of flight targets
break
elif an aerial target list corresponding to grid cells is non-null:
determine that the combat intention of the flight target is attack to air
the aerial target list is an attack-to-air target list of flight targets
break
elif a takeoff-landing area list corresponding to grid cells is non-null:
determine that the combat intention of the flight target is retreat and course reversal
the ground target list is an attack-to-ground target list of flight targets
break
elif i==n:
determine that the combat intention of the flight target is mobile retrograding
output all n predicted way point sets as a mobile retrograding prediction trajectory
break

if a flight target required to be identified currently is a combat supported aircraft:

for i in n way point sets for forward searching:
calculate the coordinate of the i(th) way point by using a method for determining the coordinates of forward way points
determine that the combat intention of the flight target is attack to ground
check the sequence numbers of corresponding grid points in a longitude and latitude sequence number comparison table of the virtual grid dictionary
if i==n:
output all n predicted way point sets as a mobile retrograding prediction trajectory
break
if the element type of an enemy plane required to be determined currently is unknown:
for i in n way point sets for forward searching:
calculate the coordinates of the i(th) way point by using a method for determining the coordinates of forward way points
check the sequence numbers of corresponding grid points in a longitude and latitude sequence number comparison table of the virtual grid dictionary
# determine in the following sequential order:
if the ground target list corresponding to grid cells is non-null:
determine that the combat intention of the flight target is attack to ground
the ground target list is an attack-to-ground target list of flight targets
break
elif an aerial target list corresponding to grid cells is non-null:
determine that the combat intention of the flight target is attack to air
the aerial target list is an attack-to-air target list of flight targets
break
elif a takeoff-landing area list corresponding to grid cells is non-null:
determine that the combat intention of the flight target is retreat and course reversal
the ground target list is an attack-to-ground target list of flight targets
break
elif i==n:
determine that the combat intention of the flight target is mobile retrograding
output all n predicted way point sets as a mobile retrograding prediction trajectory
break
elif i==n:
determine that the combat intention of the flight target is mobile retrograding
output all n predicted way point sets as a mobile retrograding prediction trajectory
break

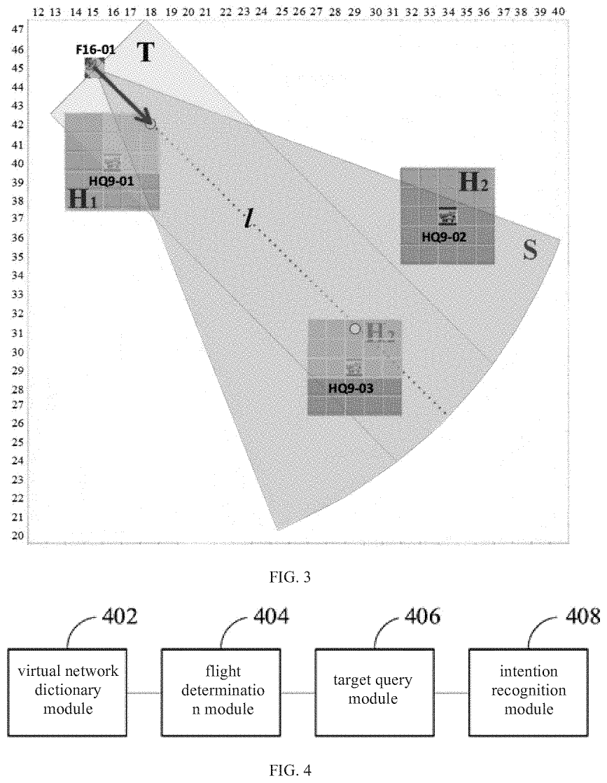

Because forward target searching is performed based on a virtual grid dictionary, as shown in FIG. 3, if a sector S search mode is adopted, an adjacent ground target HQ9-01 will be ignored and an irrelevant ground target HQ9-02 will also be identified as a possibly struck target; but once a virtual grid dictionary based search method is adopted, actually, H₁ can be accurately identified as a primary target struck by a flight target F16-01 only by judging whether a line 1 passes through an area accommodating the task target or the takeoff-landing areas H₁, H₂ and H₃, and with the continuous extension of extending lines and the more intensive setting of exploration points, the forward target searching may be equivalent to searching performed by using a rectangular surface T according to the width of a suspected attack-to-air distance, so that a function of fixed width based forward search is achieved.

It is worth noting that the first virtual grid dictionary, the second virtual grid dictionary, the first virtual grid dictionary of ground targets and the first virtual grid dictionary of aerial targets, etc. are all extended in a same grid dictionary, and essentially are the same virtual grid dictionary. In addition, when the virtual grid dictionary is updated, it is only necessary to add a new task target to the virtual grid dictionary without updating the entire virtual grid dictionary.

It should be understood that although the steps in the process diagram shown in FIG. 1 are shown successively as indicated by the arrows, these steps are not necessarily executed as indicated by the arrows. Unless expressly stated in this application, there is no strict order limitation in the execution of these steps, and these steps can be performed in other orders. Moreover, at least some of the steps in FIG. 1 may include many substeps or stages, these substeps or stages may not necessarily be completed at the same time, but may be executed at different times, the execution of these substeps or stages is not necessarily sequential, but may be carried out alternately with other steps or at least part of other substeps or stages.

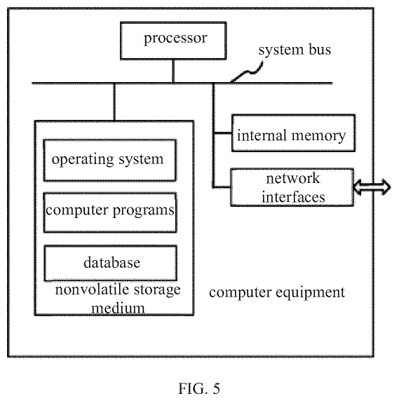

In an embodiment, as shown in FIG. 4, a virtual grid dictionary based target heading class intention recognition device is provided, and includes a virtual grid dictionary module 402, a flight determination module 404, a target querying module 406 and an intention recognition module 408, where

the virtual grid dictionary module 402 is configured to acquire the longitude and latitude data of a task space, and according to the longitude and latitude data, transform the task space into a longitude-latitude grid; and according to the longitude and latitude of a task target corresponding to a flight target and the longitude-latitude grid, build a first virtual grid dictionary corresponding to the task target, where in the first virtual grid dictionary, the task target is queried through latitudes and longitudes;

the flight determination module 404 is configured to determine whether the flight target is switched to a straight flight mode according to the longitudes and latitudes and current longitudes and latitudes of historical flight paths of the flight target;

the target querying module 406 is configured to query the task target in the flight path of the flight target according to a sensitive area corresponding to the preset task target and the first virtual grid dictionary when the flight target is in the straight flight mode, where the task target is queried according to a situation that whether the flight target is in the range of the sensitive area; and

the intention recognition module 408 is configured to determine the task type of the flight target according to the type of the task target in the expected flight path.

In one of the embodiments, the virtual grid dictionary module 402 is also configured to acquire the longitude and latitude endpoint values of the task space as Latₛ, Latₑ, Lonₛ and Lonₑ, and according to a preset length, partition the task space into a longitude-latitude grid with a latitude value interval of L_{Dlat} and a longitude value interval of L_{Dlon}:

$${N}_{lat} ∼ \{ \begin{matrix}[ {Lat}_{s} , {Lat}_{s} + {N}_{lat} \times {L}_{Dlat} ] , {N}_{lat} = 1 \\ [ {Lat}_{s} + ( {N}_{lat} - 1 ) \times {L}_{Dlat} , {Lat}_{s} + {N}_{lat} \times {L}_{Dlat} ] , {N}_{lat} > 1 \\ [ {Lat}_{s} + ( {N}_{lat} - 1 ) \times {L}_{Dlat} , {Lat}_{e} ] , {N}_{lat} = [ {Lat}_{e} / {L}_{Dlat} ]\end{matrix} \\ {N}_{lon} ∼ \{ \begin{matrix}[ {Lon}_{s} , {Lon}_{s} + {N}_{lon} \times {L}_{Dlon} ] , {N}_{lon} = 1 \\ [ {Lon}_{s} + ( {N}_{lon} - 1 ) \times {L}_{Dlon} , {Lon}_{s} + {N}_{lon} \times {L}_{Dlon} ] , {N}_{lon} > 1 \\ [ {Lon}_{s} + ( {N}_{lon} - 1 ) \times {L}_{Dlon} , {Lon}_{e} ] , {N}_{lon} = [ {Lon}_{e} / {L}_{Dlon} ]\end{matrix}$$

where the latitude sequence number of the longitude-latitude grid is Nₗₐₜ, and the longitude sequence number of the longitude-latitude grid is Nₗₒₙ.

In one of the embodiments, the virtual grid dictionary module 402 is also configured to acquire a sensitive distance D of the flight target; according to the sensitive distance D, obtain a longitude sequence number increment and a latitude sequence number increment as follows:

ΔNₗₐₜ=┌D/L_{Dlat}┐,ΔNₗₒₙ=┌D/L_{Dlon}┐

where, ΔNₗₐₜ refers to the longitude sequence number increment, ΔNₗₒₙ refers to the latitude sequence number increment, L_{Dlat} refers to the grid longitude length of the longitude-latitude grid, and the L_{Dlon} refers to the grid latitude length of the longitude-latitude grid; according to the longitude sequence numbers in the longitude-latitude grid, set up a first-order dictionary of the first virtual grid dictionary; according to the latitude sequence numbers in the longitude-latitude grid, set up a second-order dictionary of the first virtual grid dictionary; and according to the first-order dictionary and the second-order dictionary, set up a third-order dictionary, where the first virtual network is set up by the query logics of the first-order dictionary, the second-order dictionary and the third-order dictionary.

In one of the embodiments, the flight determination module 404 is also configured to determine whether the flight target is switched to the straight flight mode when an included angle between an arc formed by the line connection of two points on the approximately spherical surface of the earth and the due north direction of the earth and a course angle corresponding to the current latitudes and longitudes are less than threshold values according to the historical longitudes and latitudes and current longitudes and latitudes of more than two historical flight paths.

In one of the embodiments, the target querying module 406 is also configured to determining an expected flight path of the flight target according to the course angle of the straight flight mode when the flight target is in the straight flight mode; query whether the flight target enters the sensitive area according to the sensitive area corresponding to the preset task target, if so, query the task target corresponding to the sensitive area in the first virtual grid dictionary; and acquire the task target in the expected flight path.

In one of the embodiments, the intention recognition module 408 is also configured to determine that the task type of the flight target is a task to ground when the type of the task target in the expected flight path is a ground target; and determine that the task type of the flight target is a task to air when the type of the task target in the expected flight path is an aerial target.

In one of the embodiments, the intention recognition module 408 is also configured to set up a second virtual grid dictionary corresponding to the takeoff-landing area according to the longitude and latitude ranges corresponding to the takeoff-landing area of the flight target and the longitude-latitude grid, where in the second virtual grid dictionary, the takeoff-landing area is queried through the latitude and longitude ranges; determine a takeoff-landing area in the search scope according to the search scope and the second virtual grid dictionary; when the type of the task target in the expected flight path is the takeoff-landing area, determine that the task type of the flight target is a withdrawal and course reversal task; and when there is no search task target or takeoff-landing area in the search scope, determine that the task type that the flight target is a mobile retrograding task.

Specific limitations to the virtual grid dictionary based target heading class intention recognition device may refer to the limitations to the virtual grid dictionary based target heading class intention recognition method mentioned in the preceding part of the application, and will not be repeated here. Each module in the virtual grid dictionary based target heading class intention recognition device can be implemented completely or partly by software, hardware and combinations thereof. The modules above may be embedded into or independent of the processor of the computer equipment in hardware form, and also may be stored in the memory of the computer equipment in software form so as to facilitate the processor to invoke and perform the corresponding operations of the modules above.

In one embodiment, computer equipment is provided, the computer equipment may be a server, and the internal structure diagram thereof may be shown in FIG. 5. The computer equipment includes a processor, a memory, a network interface and a database which are connected through a system bus, where the processor of the computer equipment is configured to provide computing and controlling capabilities. The memory of the computer equipment includes a nonvolatile storage medium and an internal memory. The nonvolatile storage medium is configured to store an operating system, computer programs and a database. The internal memory is configured to provide an environment for the operation of the operating system and the computer programs in the nonvolatile storage medium. The database of the computer equipment is configured to store grid data. The network interface of the computer equipment is configured to communicate with an external terminal through network connection. The computer programs are executed by the processor so as to implement a virtual grid dictionary based target heading class intention recognition the method.

Persons of ordinary skill in the art should understand that the structure shown in FIG. 5 is only a block diagram of a partial structure relevant to this application, and not intended to limit the computer equipment applied thereon in this application, specific computer equipment may include components more or less than those shown in the figure, or combine some parts, or have different component arrangements.

In one embodiment, computer equipment is provided, and includes a memory and a processor, where the memory is configured to store computer programs, and when the processor executes the computer programs, the steps of the method in the embodiment above are implemented.

In one embodiment, a computer-readable storage medium is provided, which is configured to store computer programs, and the steps of the method in the embodiment above are implemented when the computer programs are executed by the processor.

Persons of ordinary skill in the art may understand that the implementation of all or part of the process in the method of the embodiments above can be completed by related hardware instructed by the computer programs, the computer programs can be stored in a nonvolatile computer-readable storage medium, and when the computer programs are executed, the processes of the embodiments of each method above can be included. Where, any reference to the memory, the storage medium, the database or other mediums used in each embodiment provided by this application may include a nonvolatile and/or volatile memory. A nonvolatile memory may be a read-only memory (ROM), a programmable ROM (PROM), an electrically programmable ROM (EPROM), an electrically erasable programmable ROM (EEPROM) or a flash memory. A volatile memory may be a random access memory (RAM) or an external cache memory. As an illustration rather than a limitation, the RAM is available in many forms, such as static RAM (SRAM), dynamic RAM (DRAM), synchronous DRAM (SDRAM), dual data rate SDRAM (DDRSDRAM), enhanced SDRAM (ESDRAM), Synchlink DRAM (SLDRAM), Rambus direct RAM (RDRAM), direct memory bus dynamic RAM (DRDRAM), and memory bus dynamic RAM (RDRAM), etc.

The technical features of the embodiments above may be combined in any way, and for achieving brief description, not all possible combinations of the technical features in the embodiments above are described, however, in case that no contradiction exists in the combinations of these technical features, the combinations shall be considered to be within the scope of this specification.

The embodiments above only express several embodiments of this application, and are described relatively specifically and detailedly, but cannot be construed as a restriction on the scope of the invention. It should be noted that many variations and improvements may be made by persons of ordinary skill in the art without departing from the conception of this application, and the variations and improvements shall fall within the protection scope of the application. Therefore, the protection scope of the patent of the application shall be subject to the attached claims.

1. A virtual grid dictionary based target heading class intention recognition method, wherein the method comprising the following steps of:
acquiring the longitude and latitude data of a task space, transforming the task space into a longitude-latitude grid according to the longitude and latitude data, and according to the longitude and latitude of a task target corresponding to a flight target and the longitude-latitude grid, setting up a first virtual grid dictionary corresponding to the task target, where the first virtual grid dictionary is configured to query the task target through latitudes and longitudes;
according to the current longitudes and latitudes and longitudes and latitudes of historical flight paths of the flight target, determining whether the flight target is switched to a straight flight mode;
when the flight target is in the straight flight mode, according to a sensitive area corresponding to the preset task target and the first virtual grid dictionary, querying the task target in the flight path of the flight target, where the task target is queried according to a situation that whether the flight target is in the range of the sensitive area; and
determining the task type of the flight target according to the type of the task target in the expected flight path.

2. The method according to claim 1, wherein the step of acquiring the longitude and latitude data of a task space, and transforming the task space into a longitude-latitude grid according to the longitude and latitude data comprises:
acquiring the longitude and latitude endpoint values of the task space as Latₛ, Latₑ, Lonₛ and Lonₑ, and according to a preset length, partitioning the task space into a longitude-latitude grid with a latitude value interval of L_{Dlat} and a longitude value interval of L_{Dlon}:
$${N}_{lat} ∼ \{ \begin{matrix}[ {Lat}_{s} , {Lat}_{s} + {N}_{lat} \times {L}_{Dlat} ] , {N}_{lat} = 1 \\ [ {Lat}_{s} + ( {N}_{lat} - 1 ) \times {L}_{Dlat} , {Lat}_{s} + {N}_{lat} \times {L}_{Dlat} ] , {N}_{lat} > 1 \\ [ {Lat}_{s} + ( {N}_{lat} - 1 ) \times {L}_{Dlat} , {Lat}_{e} ] , {N}_{lat} = [ {Lat}_{e} / {L}_{Dlat} ]\end{matrix} \\ {N}_{lon} ∼ \{ \begin{matrix}[ {Lon}_{s} , {Lon}_{s} + {N}_{lon} \times {L}_{Dlon} ] , {N}_{lon} = 1 \\ [ {Lon}_{s} + ( {N}_{lon} - 1 ) \times {L}_{Dlon} , {Lon}_{s} + {N}_{lon} \times {L}_{Dlon} ] , {N}_{lon} > 1 \\ [ {Lon}_{s} + ( {N}_{lon} - 1 ) \times {L}_{Dlon} , {Lon}_{e} ] , {N}_{lon} = [ {Lon}_{e} / {L}_{Dlon} ]\end{matrix}$$
where the latitude sequence number of the longitude-latitude grid is Nₗₐₜ, and the longitude sequence number of the longitude-latitude grid is Nₗₒₙ.

3. The method according to claim 1, wherein the step of setting up a first virtual grid dictionary corresponding to a task target according to the longitude and latitude of the task target corresponding to a flight target and the longitude-latitude grid comprises the substeps of:
acquiring a sensitive distance D corresponding to the sensitive area of the task target;
according to the sensitive distance D, obtaining a longitude sequence number increment and a latitude sequence number increment:
ΔNₗₐₜ=┌D/L_{Dlat}┐,ΔNₗₒₙ=┌D/L_{Dlon}┐
where, ΔNₗₐₜ refers to the longitude sequence number increment, ΔNₗₒₙ refers to the latitude sequence number increment, L_{Dlat} refers to the grid longitude length of the longitude-latitude grid, and the L_{Dlon} refers to the grid latitude length of the longitude-latitude grid;
setting up a first-order dictionary of the first virtual grid dictionary according to longitude sequence numbers in the longitude-latitude grid; and
setting up a second-order dictionary of the first virtual grid dictionary according to latitude sequence numbers in the longitude-latitude grid;
setting up a third-order dictionary according to the first-order dictionary and the second-order dictionary, where a first virtual network is set up by the query logics of the first-order dictionary, the second-order dictionary and the third-order dictionary.

4. The method according to claim 1, wherein the step of determining whether the flight target is switched to a straight flight mode according to the longitudes and latitudes and current longitudes and latitudes of historical flight paths of the flight target, comprises:
according to the historical and current longitudes and latitudes of more than two historical flight paths, when angle between an arc formed by the line connection of two points on the ellipsoidal surface of the earth and the due north direction of the earth and a course angle corresponding to the current latitudes and longitudes are less than threshold values, determining whether the flight target is switched to the straight flight mode.

5. The method according to claim 1, wherein the step of querying the task target in the flight path of the flight target according to a sensitive area corresponding to the preset task target and the first virtual grid dictionary when the flight target is in the straight flight mode comprises the substeps of:
determining an expected flight path of the flight target according to the course angle of the straight flight mode when the flight target is in the straight flight mode;
querying whether the flight target enters the sensitive area according to the sensitive area corresponding to the preset task target, if so, querying the task target corresponding to the sensitive area in the first virtual grid dictionary; and
acquiring the task target in the expected flight path.

6. The method according to claim 5, wherein the step of determining the task type of the flight target according to the type of the task target in the expected flight path comprises the substeps of:
when the type of the task target in the expected flight path is a ground target, determining that the task type of the flight target is a task to ground; and
when the type of the task target in the expected flight path is an aerial target, determining that the task type of the flight target is a task to air.

7. The method according to claim 6, wherein the method also comprises the steps of:
according to the longitude and latitude ranges corresponding to a takeoff-landing area of the flight target and the longitude-latitude grid, setting up a second virtual grid dictionary corresponding to the takeoff-landing area, where in the second virtual grid dictionary, the takeoff-landing area is queried through the latitude and longitude ranges;
according to a search scope and the second virtual grid dictionary, determining a takeoff-landing area in the search scope;
when the type of the task target in the expected flight path is the takeoff-landing area, determining that the task type of the flight target is a withdrawal and course reversal task; and
when there is no search task target or takeoff-landing area in the search scope, when the type of the task target in the expected flight path is the takeoff-landing area

8. A virtual grid dictionary based target heading class intention recognition device, wherein the device comprising:
a virtual grid dictionary module, configured to acquire the longitude and latitude data of a task space, and according to the longitude and latitude data, transform the task space into a longitude-latitude grid; and according to the longitude and latitude of a task target corresponding to a flight target and the longitude-latitude grid, build a first virtual grid dictionary corresponding to the task target, where the first virtual grid dictionary, the task target is queried through latitudes and longitudes;
a flight determination module, configured to determine whether the flight target is switched to a straight flight mode according to the longitudes and latitudes and current longitudes and latitudes of historical flight paths of the flight target;
a target querying module, configured to query the task target in the flight path of the flight target according to a sensitive area corresponding to the preset task target and the first virtual grid dictionary when the flight target is in the straight flight mode, where the task target is queried according to a situation that whether the flight target is in the range of the sensitive area; and
an intention recognition module, configured to determine the task type of the flight target according to the type of the task target in the expected flight path.

9. A computer equipment, comprising a memory and a processor, where the memory stores computer programs, wherein, the steps of the method according to claim 1 are implemented when the processor executes the computer programs.

10. A computer-readable storage medium in which computer programs are stored, wherein the steps of the method according to claim 1 are implemented when the computer programs are executed by the processor.
